(19) United States
(12) Patent Application Publication
(10) Pub. No.: US 2014/0125454 A1
(43) Pub. Date: May 8, 2014

(54) LOCKBOX STORAGE APPARATUS

(71) Applicant: Aileen De Maria, Yonker, NY (US)

(72) Inventor: Aileen De Maria, Yonker, NY (US)

(21) Appl. No.: 14/155,135

(22) Filed: Jan. 14, 2014

Related U.S. Application Data
(63) Continuation-in-part of application No. 13/022,738, filed on Feb. 8, 2011.

(51) Int. Cl. G07C 9/00; E05B 47/00

(52) U.S. Cl. CPC G07C 9/00912; E05B 47/00
USPC 340/5.73; 70/63

(57) ABSTRACT

A lockbox storage apparatus comprising a pair of side walls on each side of said lockbox storage apparatus, a door attached to a front portion of said lockbox storage apparatus, where said door is attached between said pair of side walls, a top panel affixed to a top portion of said lockbox storage apparatus, a lock attached to said door, where said lock secures said door against one of said pair of side wall, a back wall opposite to said door, where said back wall is attached between said pair of side walls, an inner panel fastened within said lockbox storage apparatus, where said inner panel rest against said back wall, a plurality of attachment means arranged against said inner panel, and a plurality of lockboxes hanging from said attachment means wherein said plurality of lockboxes include a key to enable a user to access a property.

### CROSS REFERENCE TO OTHER APPLICATIONS

This application claims priority to U.S. patent application Ser. No. 13/022,738 filed on Feb. 8, 2011.

### BACKGROUND OF THE INVENTION

1. Field of the Invention

The present invention relates to a storage unit to house multiple lockboxes, those typically used by real estate agents, brokers or building owners, so that all of the lockboxes are contained in one location.

2. Description of Related Art

Commonly, lockboxes are used by real estate agents and property managers as a way to keep a key accessible to those wishing to enter a residential property or office, by placing the lockbox outside the property in a publically accessible area. Individuals normally use a code or number sequence to open a lockbox to access the inner key. Sometimes the lockboxes are placed on the door handles of the locked properties so that the agent may simply enter the code and then immediately open the property door. The practice of placing the individual lockboxes door handles is common on residential houses where one agent may be showing one house at a time. Other times, the lockboxes are placed on a gate, fence, entrance area or stairwell at the property causing multiple lockboxes to be arranged at one location. This practice is common at apartment buildings or townhome complexes where the agent may be showing more than one unit in the complex. Multiple lockboxes hanging on a gate or in a stairwell creates an eyesore, undesirable to those living in the complex and to the potential clients.

It would be beneficial in the art to provide a storage container to house multiple lockboxes in one location to keep common areas of a residential complex organized. It would also be desirable to provide a container that can be locked to prevent theft or unauthorized access to the internal lockboxes.

### SUMMARY OF THE INVENTION

An object of the present invention is to provide a storage apparatus to house a plurality of lockboxes so that the lockboxes are keep in a single location for greater organization.

Another object of the present invention is to provide a storage apparatus with a lock as to prevent theft or unauthorized access to the plurality of inner lockboxes.

In view of the foregoing disadvantages inherent in the prior art, present invention relates to provide a lockbox storage apparatus comprising a pair of side walls on each side of said lockbox storage apparatus, a door attached to a front portion of said lockbox storage apparatus, where said door is attached between said pair of side walls, a top panel affixed to a top portion of said lockbox storage apparatus, a lock attached to said door, where said lock secures said door against one of said pair of side wall, a back wall opposite to said door, where said back wall is attached between said pair of side walls, an inner panel fastened within said lockbox storage apparatus, where said inner panel rest against said back wall, a plurality of attachment means arranged against said inner panel, and a plurality of lockboxes hanging from said attachment means wherein said plurality of lockboxes include a key to enable a user to access a property.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a lockbox storage apparatus in accordance with an exemplary embodiment of the present invention; and

FIG. 2 depicts a perspective view of an inner panel of the lockbox storage apparatus in accordance with an exemplary embodiment of the present invention.

Like reference numerals refer to like parts throughout the description of several views of the drawings.

### DETAILED DESCRIPTION OF THE DRAWINGS

The present invention relates to a storage unit to house multiple lockboxes, those typically used by real estate agents, brokers or building owners, so that all of the lockboxes are contained in one location. The present invention discloses a lockbox storage apparatus as an improved way to organize and store the lockboxes used in real estate property sales. The lockbox storage apparatus includes an inner panel with multiple hooks to attach the various lockboxes. The apparatus may be located at a designated area and mounted to a wall to enable a user to gain access to the inner lockboxes. The lockbox storage apparatus may include a lock to prevent theft and limit access to the privileged users who have permission to show the properties. Therefore, the lockboxes may all be kept in a single container for user convenience and property organization.

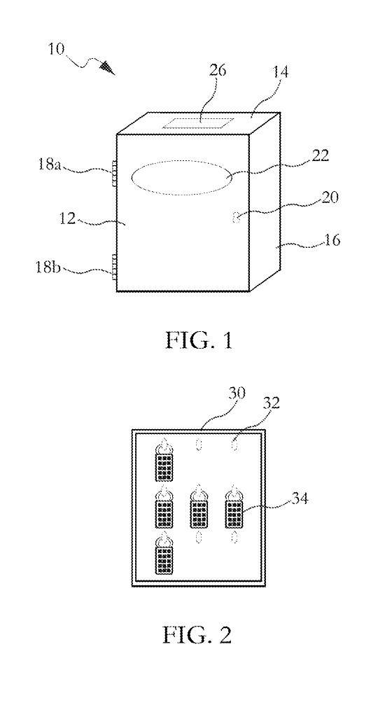

Turning now descriptively to the drawings, referring to FIG. 1, a perspective view of a lockbox storage apparatus (10) is shown in accordance with an exemplary embodiment of the present invention. The lockbox storage apparatus (10) comprises a generally cuboid shape including a door (12), a top panel (14), a base panel, a back wall and a pair of side walls (16) (hereinafter side walls). The lockbox storage apparatus (10) is a closed structure similar to a small cabinet or a safe, wherein the door (12) is arranged between the side walls (16), the back wall opposes the door (12) and rests between the said walls (16), the top panel (14) is attached against a top portion of the lockbox storage apparatus (10), and the base panel opposes the top panel along a bottom portion of the lockbox storage apparatus (10).

The lockbox storage apparatus (10) may be made from a strong metallic material or wood. The strong metallic material or wood may provide greater security and durability. The lockbox storage apparatus (10) may be mounted to the wall to provide a convenient storage location.

The door (12) is attached to a front portion of the lockbox storage apparatus (10). On one side of the door (12) may be a set of hinges (18a, 18b) to affix the door (12) to one of the sidewalls (16). The set of hinges (18a, 18b) may enable the door (12) to swing from an open position to a closed position. When in the open position, the door (12) allows a user to access the contents inside the lockbox storage apparatus (10), whereas when in the closed position the door (12) prevents access. The hinges (18a, 18b) remain inside the apparatus (10) when in a closed position and therefore avoid a risk of tampering with the hinges (18a, 18b).

On an opposing side of the door (12) may be a lock (20). The lock (20) secures the door (12) in the closed position against the front portion of the lockbox storage apparatus (10). The lock (20) may be a conventional cylinder keylock. Alternatively, an electronic lock or a combination lock may be used wherein the user enters a code to open the lock (20). Use of an electronic lock requiring a code may enable information gathering features such as storing or recording multiple access codes used to enter the lockbox storage apparatus (10). In such an embodiment, the lock (20) includes memory that stores access codes entered over a predetermined period of time. By recording the entered codes the lock's memory effectively logs the use of the lockbox storage apparatus (10). The lockbox storage apparatus (10) may be accessible by multiple number codes created by the principle user or owner. The memory connected to the electronic lock may store and record data upon entry of the code input into said electronic lock, wherein said data includes a time stamp of code entry, a record of number of times a particular code has been used, an indication of which lockbox has been removed; and a tally of lockboxes available at the time of code entry. Sensors may be provided on each lockbox that may be used to detect the removal of and entry of any lockboxes to the storage apparatus (10). A storage apparatus sensor is used in conjunction with the lockbox sensors.

Attached against the front portion of the door (12) may be a face plate (22). The face place (22) enables the user to affix their company name, property name or another identification indicator to the lockbox storage apparatus (10). Along the top panel (14) may be a hole (26). The hole (26) may enable the user to slide a key or a lockbox into the inner cavity of the lockbox storage apparatus (10) after use. The hole (26) may provide a drop off location to enable the user to return the keys without having to unlock the lock (20).

Referring now to FIG. 2, a perspective view of an inner panel (30) of the lockbox storage apparatus (10) is shown in accordance with an exemplary embodiment of the present invention. The inner panel (30) fits against the back wall. Arranged against the inner panel (30) may be a plurality of attachment means (32) (hereinafter attachment means). The attachment means (32) may be a set of hooks or a set of magnets.

Hanging from the attachment means (32) may be a plurality of lockboxes (34) (hereinafter lockboxes). The lockboxes (34) are commonly used by real estate agents or brokers when selling/renting houses. The each lockbox (34) contains a key which coordinates with a specific lock to a residential unit. The keys open the doors to individual residential units so that the agent may enter the unit without the owner being present. The lockboxes (34) each have their own security code to allow access to the key inside. This way the individual brokers may place their own lockboxes (34) into the lockbox storage apparatus (10) for each of their units.

By providing a lockbox storage apparatus (10) the brokers have a place to store all of their lockboxes (34) without causing a mess or an eyesore to the gates, fences, stairwells or entrances of the property where their residential units are located. The lockbox storage apparatus (10) may deter theft and vandalizing by keeping the lockboxes (34) contained and in a secure location. When the lockboxes (34) are contained the conventional method of leaving the lockboxes (34) at sporadic locations is eliminated thus providing greater organization and cleanliness at the properties. Therefore, lockbox storage apparatus (10) may be used by real estate agents, property managers or owners, lock smiths and the like to provide an organized and convenient location to store their lockboxes.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A lockbox storage apparatus comprising:
a pair of side walls on opposing vertical sides of said lockbox storage apparatus;
a door attached to a front portion of said lockbox storage apparatus, where said door is attached between said pair of side walls, and where said door includes a faceplate, where the faceplate displays an identifier;
a top panel, where said top panel is affixed to a top portion of said lockbox storage apparatus, where said top panel includes a hole;
a lock attached to said door, where said lock secures said door against a wall selected from said pair of side walls, and where said lock is an electronic lock requiring a code to open said lock;
a memory connected to the electronic lock to store and record data upon entry of the code input into said electronic lock, wherein said data includes a time stamp of code entry, a record of number of times a particular code has been used, an indication of which lockbox has been removed; and a tally of lockboxes available at the time of code entry;
a back wall opposite to said door, where said back wall is attached between said pair of side walls;
an inner panel fastened within said lockbox storage apparatus, where said inner panel rests against said back wall;
a plurality of attachment means arranged against said inner panel;
a plurality of lockboxes hanging from said attachment means wherein said plurality of lockboxes include a key to enable a user to access a property, and where said plurality of lockboxes fit through said hole in said top panel;
a sensor on each lockbox, where the sensor provides an indication of removal and return of each lockbox; and
a second sensor within the lockbox storage apparatus detecting the removal and return of each lockbox.

2. The lockbox storage apparatus according to claim 1, wherein said door is fastened against an opposing side wall from said wall selected from said pair of side walls with a set of hinges.

3. The lockbox storage apparatus according to claim 2, wherein said set of hinges enable said door to swing from an open position to a closed position.

4. The lockbox storage apparatus according to claim 1, wherein said lock is a chamber lock.

5. The lockbox storage apparatus according to claim 1, wherein said plurality of attachment means is a plurality of hooks to hang said plurality of lockboxes.

6. The lockbox storage apparatus according to claim 1, wherein said plurality of attachment means is a plurality of magnets to hang said plurality of lockboxes.

7. The lockbox storage apparatus according to claim 1, where the memory includes a timestamp to record which lockboxes from said plurality of lockboxes are removed.

8. The lockbox storage apparatus according to claim 1, where the lockbox storage apparatus is made from one of at least wood and metal.

9. A method of storing and retrieving lockboxes comprising the steps of:
storing a plurality of lock boxes in a storage apparatus, where the storage apparatus includes an entry door with an electronic lock and an access hole on a top panel of the apparatus;
assigning a unique user code for each user of the storage apparatus, where the user code allows entry into the storage apparatus;
placing a plurality of lock boxes within the storage apparatus; and
storing specific data in memory whenever any user inputs their unique user code to open the entry door.

10. The method according to claim 9, where the specific data includes a time stamp of code entry, a record of number of times a particular code has been used, an indication of which lockbox has been removed; and a tally of lockboxes available at the time of code entry.

11. The method according to claim 10, where the access hole includes a sensor detecting return of any lockbox into the storage apparatus.
